(19) United States
(12) Patent Application Publication
(10) Pub. No.: US 2011/0228630 A1
(43) Pub. Date: Sep. 22, 2011

(54) Reduced Transit Static Mixer Configuration

(75) Inventors: Paul A. Gillis, Lake Jackson, TX (US); Joerg-Peter Gehrke, Stade (DE); Artur Klinger, Stade (DE); Hua Bai, Lake Jackson, TX (US)

(73) Assignee: DOW GLOBAL TECHNOLOGIES, INC., Midland, MI (US)

(21) Appl. No.: 12/725,262

(22) Filed: Mar. 16, 2010

(51) Int. Cl. B01F 15/02

(52) U.S. Cl. 366/184

(57) ABSTRACT

Excessive residence time in the conduits located between the outlet of a static mixer and a reactor/separator reservoir can lead to undesired by-products, formation of solids, and conduit fouling. This disclosure relates to an improved configuration for a static mixer with reduced transitory time to help reduce the creation of undesired by-products and fouling during the process of mixing, and more particularly to a phosgene reactor comprising a short or very short conduit for reducing the transit time from the static mixer to a reactor/separator reservoir to one second or less.

### FIELD OF THE DISCLOSURE

This disclosure relates to an improved configuration for a static mixer with reduced transitory time to help reduce the creation of undesired by-products and fouling during the process of mixing, and more particularly to a phosgene and amine reactor with a short or very short output conduit for reducing the reactant mixture transit time from the static mixer to a reactor/separator reservoir to one second or less.

### BACKGROUND

Isocyanates are molecules characterized by N═C═O functional groups. The most widely used isocyanates are aromatic compounds derived from benzene. Two polyisocyanates are widely produced commercially, namely, toluene diisocyanate (TDI) and polymeric methylenediphenyl-diisocyanate (PMDI). PMDI is a mixture of polymethylene diisocyanate and the two monomeric methylenediphenyldiisocyate isomers. Ultimately, these isocyanates are reacted with polyols to form polyurethanes. Two of the major polyurethane applications are rigid foams for appliance insulation and automotive parts and flexible foams for mattresses and seating.

Mixing is important in PMDI and TDI production. The PMDI product quality and TDI yield is dependent on a multistep chemical reaction network, including a first step where two continuous streams of reactants are directed into a mixer and where, because of the residual reactivity of the compound produced in a first step of the process, secondary effects or reactions created after the primary reaction occur and ultimately reduce the quality of the product composition. For example, in the case of phosgenation chemistry, methylenedi(phenylamine) (MDA or PMDA), also referred to herein as amine, is mixed with COCl₂ (phosgene) to create a mixture of Hydrochloric Acid (HCl) and Carbamyl Chlorides. The chemical reaction can be depicted as follows:

Amine+COCl₂->HCl+Carbamyl Chloride

The carbamyl Chloride will then decompose to the isocyanate. While the production of isocyanates is desired, secondary reactions can lead to the creation of undesired by-products. Some of these secondary reactions are believed to produce products as amine hydrochloride, urea, and carbodiimides.

Since the formation of by-products, such as urea and/or Added Product A (APA) is undesirable, the increase of the ratio of phosgene to PMDA in a solvent, a dilution of PMDA in a solvent, or an improved mixing without unwanted mixing minimizes the formation of undesired by-products and fouling. Many known and unknown factors control the quality of the principal reaction. The quality and rate of mixing can be affected by equipment fouling, or plugging of the jets within the mixer, which in turn results in a decreased performance. Over the course of time, caking and subsequent clogging disturbs the injection and distribution of fluid flow through the inlet jets of PMDA in static mixers. For example, at the outlet of static mixers, a long pipe or tube a.k.a. a conduit transports the reaction mixture. This mixture is further reacting, producing heat, and changing in gas/liquid composition as it flows to a downstream reactor/separator reservoir.

The risk of fouling decreases when the substance that passes through a nozzle is dissolved or suspended in a solvent or any other suspending medium. Fouling may also occur on equipment surfaces as a result of secondary reactions. When fouling and/or clogging occurs, a continuous process has to be interrupted and the static mixers taken apart and cleaned, resulting in undesirable and costly idle periods. Where hazardous substances are used, industrial hygiene regulations necessitate expensive measures during the disassembly of the static mixers, such as the thorough flushing of the system before disassembly, exhaustion of the atmosphere, protective clothing, and breathing apparatuses for the workers. Each of these measures adds to the overall cost, reduces throughput, and reduces the efficiency of the process.

Some chemical reactions require proper mixing to reduce secondary reactions. Proper mixing can prevent a product of an initial reaction to react with another component in the reaction stream to generate an undesired product in a secondary reaction. Improper mixing can contribute to byproduct formation and static mixer fouling. Consequently, static mixer designs that do not promote proper mixing can lead to lower overall yield of the desired product or can generate a product that clogs or fouls the reactor system leading to down time and/or increased maintenance costs.

In a first type of static mixer, phosgene is transported along the axis of the device and PMDA is inserted from a circumferential orifice into the main stream of phosgene using a multi-tee mixer. In a second type of static mixer, phosgene is transported along the axis of the device and PMDA is inserted circumferentially at spaced locations around an internal structure disposed in the phosgene stream to create an annular mixing area. Such a structure is shown and is fully described, in U.S. application Ser. No. ______, filed on ______ incorporated fully by reference herein. Novel static mixers are useful to reduce undesired byproducts of a reaction, but they are often insufficient to optimize the overall reaction and associated rate of production of isocyanate and still result in some level of undesired fouling.

Amine phosgenation chemistry requires proper mixing between reaction streams. The PMDA reacts with the carbamyl chloride and the isocyanates to create undesired by-products. Ultimately, the objective of the formation process is to avoid secondary reactions and the creation of APA.

In the manufacture of TDI, the undesired products, namely, tars, must be subsequently separated from the isocyanate. Improved focus on the principal reaction and avoidance of the secondary reactions described above leads to an increase in production capacity. Conversely, in PMDI production, the undesired product APA is sold as an impurity in the product and the key design objective with respect to reaction selectivity is to maintain acceptable APA levels in the final product. Mixing efficiency declines and hence secondary reactions occur more often as the volumetric flow is increased, and as a result, the undesired level of impurities is increased.

U.S. patent application Ser. No. 10/539,802 describes a new method for the continuous production of isocyanates for a two-stage or multistage process that gives a very high chemical yield and a low holdup. This method relies on the control of pressure and temperature at different stages of the process to optimize the different reactions. Temperature increases are controlled partly by controlling the transitory time at different reservoirs in the overall process.

U.S. patent application Ser. No. 10/539,802 teaches how the continuous process and the associated mixture is carried out in three stages: a first stage for mixing the amine and the phosgene to form carbamyl chloride and hydrogen chloride and the amine hydrochloride in a very fast reaction, the next two stages for decomposition of the carbamyl chloride to form the desired isocyanate and hydrogen chloride and the phosgenation of the amine hydrochloride to form the carbamyl chloride. One way to limit byproduct and solid formation is to solubilize the products in organic solvents and mix them quickly at the reactor. The temperature achieved at the second stage of the described process is generally higher than the temperature at the first stage.

U.S. patent application Ser. No. 10/539,802, as with all of the prior art, describes a passage from a mixing reactor of the first stage to the reactor of the second stage via a pipe, or a tube with a nozzle. The '802 application describes a reaction with a residence time at the second stage in the range of one second to thirty minutes, with a preference as a mean residence time of thirty seconds to ten minutes, and even more preferred mean residence time of two to seven minutes. Residence time as described above remains high and still produce unacceptable undesired by-products and solids in the system. This reference does not teach how the pipe or tube at the exit of the first stage reactor influences the process or creates secondary effects in the overall process.

Publication US 2006/0041166 A1 describes placing the phosgene and amine mixer inside the reactor vessel as shown in FIG. 1. A portion of the phosgene is recirculated and mixed with fresh phosgene at a rectification system for the discharge of HCI. A discharge end from the jet mixer is inserted deep into the reactor to a point where the discharge can be immediately heated. The system shown in FIG. 1 provides for a jet mixer operating at a temperature inferior to the temperature in the reactor. The discharge end is positioned below a liquid surface in the reactor and is used as a jet to create a circulation pattern in the reactor.

FIG. 2 shows a typical configuration where the continuous flow of PMDI is mixed with the continuous flow of COCl₂ in a static phosgene mixer. In this configuration, the mixture travels the distance B before it reaches section valves of a reactor/separator reservoir. These section valves are not necessary and may be used to help dismantle and clean the static mixer.

All static mixers are currently located at a distance from the reservoir/separator and require frequent maintenance because fouling occurs. Maintenance is generally needed in the conduit on the outlet of these mixers at a location often next to the downstream reservoir/separator. Cleaning these conduits represents a risk and an important maintenance cost.

What is needed is an improved process capable of increasing the capacity of static mixers while reducing the need for conduit maintenance and associated risks. What is also needed is a new process for limiting the production of impurities and fouling, and other solids produced by the static mixer.

### SUMMARY

Excessive residence time in the conduits located between the outlet of a static mixer and a reactor/separator reservoir can lead to undesired by-products, formation of solids, and conduit fouling. This disclosure relates to an improved configuration for a static mixer with reduced transitory time to help reduce the creation of undesired by-products and fouling during the process of mixing, and more particularly to a phosgene reactor comprising a short or very short conduit for reducing the transit time from the static mixer to a reactor/separator reservoir to one second or less.

### BRIEF DESCRIPTION OF THE DRAWINGS

Certain preferred embodiments are shown in the drawings. However, it is understood that the present disclosure is not limited to the arrangements and instrumentality shown in the attached drawings.

FIG. 1 is a process for the continuous preparation of Isocyanates according to US 2006/0041166 A1.

FIG. 2 is an illustration of a static mixer with a long conduit to a reactor/separator reservoir according to the prior art.

FIG. 3 is an illustration of a reduced transit static mixer configuration according to an embodiment of the present disclosure.

FIG. 4 is a bar chart illustrating the possible residence time of the reactive mixture exiting the static mixer from the prior art as shown on FIG. 2 when compared with the residence time in a reduced transit phosgene mixer as shown at FIG. 3 for two different production rates.

FIG. 5 is an illustration of a reduced transit phosgene static mixer according to another embodiment.

FIG. 6 is an illustration of a reduced transit mixer as shown at FIG. 5 where the mixer is a static mixer with a guide element according to another embodiment of the present disclosure.

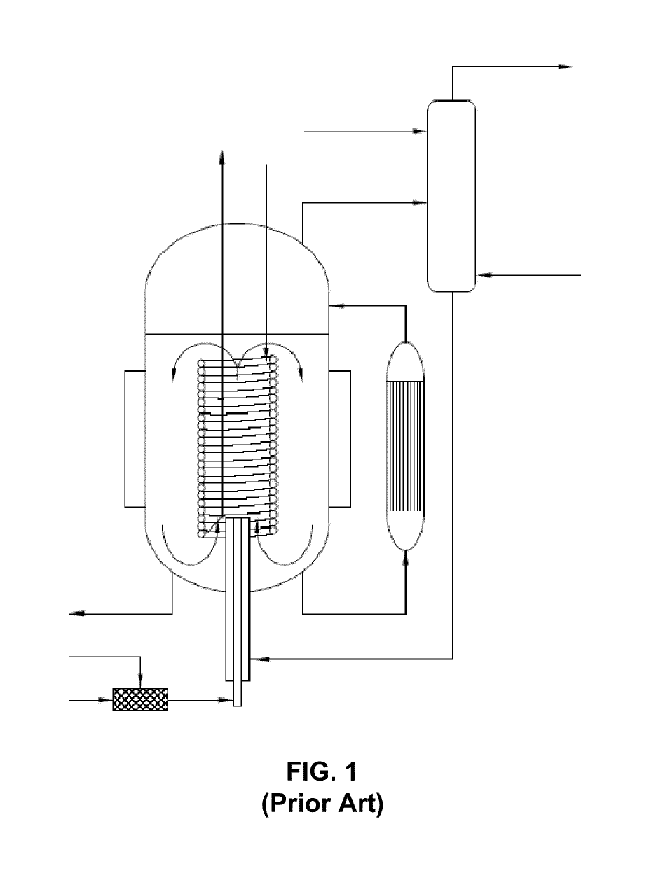

### DETAILED DESCRIPTION

For the purposes of promoting and understanding the invention and principles disclosed herein, reference is now made to the preferred embodiments illustrated in the drawings, and specific language is used to describe the same. It is nevertheless understood that no limitation of the scope of the invention is thereby intended. Such alterations and further modifications in the illustrated devices and such further applications of the principles disclosed as illustrated herein are contemplated as would normally occur to one skilled in the art to which this disclosure relates.

Reduction of conduit fouling and fouling in general in connection with the production of organic isocyanates is desired. Some solids are formed during the chemical reaction of the phosgene and amine mixing process. The hazardous nature of these chemicals increase the difficulties associated with the maintenance of conduits on the outlet of static mixers. These solids travel through pipes and ultimately lodge themselves in reactor/separator reservoirs or may even foul the conduit at the outlet of a mixer. Removal or a reduction in the length of a conduit at the outlet of static mixers is desirable.

Different configurations of outlet conduits of static mixers show that different geometries of conduits, a variation of the diameter of the conduits or a variation of the length of the conduits has an influence on the undesired by-products and fouling of conduits.

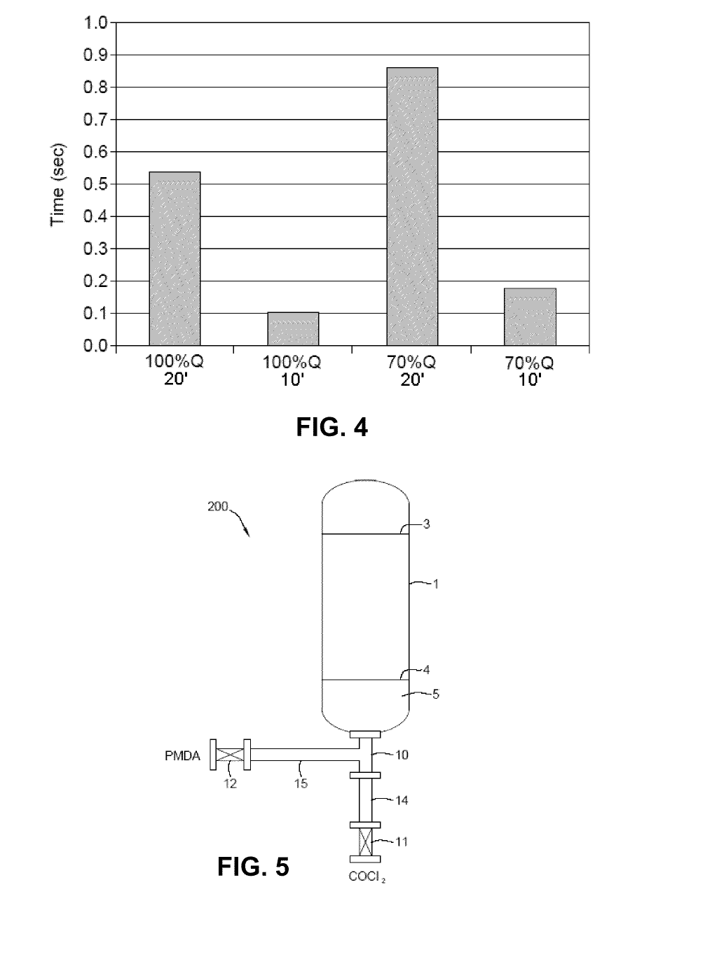

FIG. 4 illustrates a configuration where a short conduit of for example no more than approximately 10 feet and a long conduit of for example no more than approximately 20 feet are connected to the outlet of a static mixer at a full flow of 100% of phosgene and amine (100% Q) as a mixture. The table also illustrates a reduced flow of 70% of phosgene and amine (70% Q) as a mixture. The figure further demonstrates that a reduction of 50% in length of the conduit decreases by more than 50% the transitory time for both full and reduced flow. Variable vaporization in the conduit causes the non-linear relationship between length and residence time. Long conduits at the outlet of static phosgene mixers are undesirable and should be removed or shortened when possible.

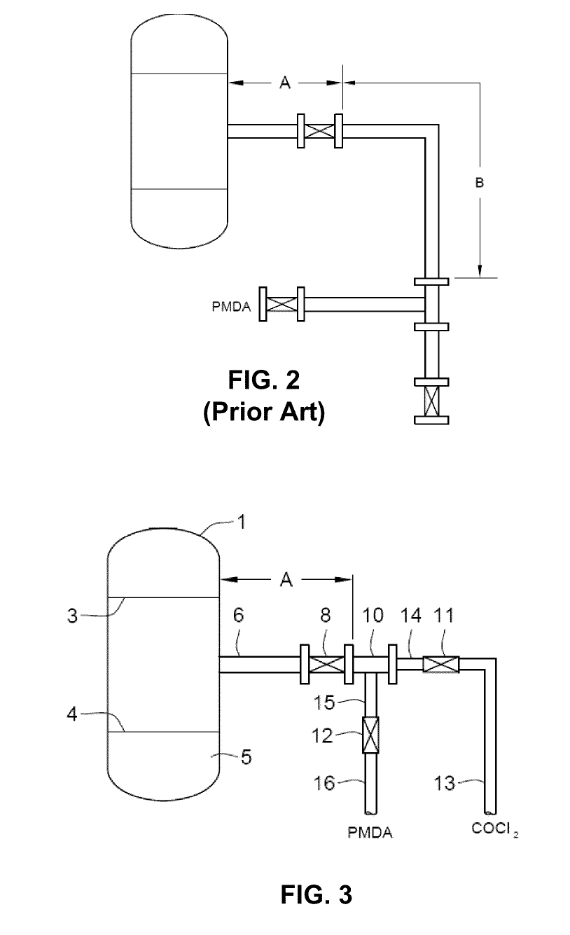

In FIG. 3, the static mixer 10 is disposed directly adjacent to a reactor valve 8. When the configurations shown in FIGS. 2 and 3 are compared, the distance between the static mixer 10 and the reactor/separator reservoir 1 is reduced from A+B to A. A first conduit 13, and 14 along with any control or regulation valve 11 transports a continuous flow of phosgene (COCl₂) into the static mixer 10. A second conduit 16, and 15 also possibly equipped with a control or regulation valve 12 regulates the arrival of a continuous flow of PMDA into the static mixer 10. Once the components are mixed in the static mixer 10, the mixture travels exits an outlet of the static mixer 10 by a connection pipe 6 and the mixture then arrives into the reactor/separator reservoir 1 after a transit into the conduit for a period described as a residence time.

In an example of one embodiment, an approximately 20 foot conduit between the static mixer 10 has an operational life of only 6 days. When the conduit length is reduced to approximately 10 feet as shown for example at FIG. 3, the operational life is increased to above 40 days.

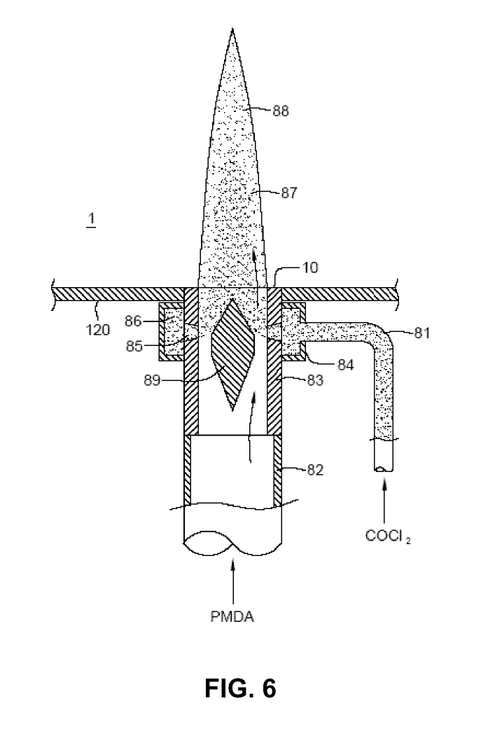

In another configuration shown in FIGS. 5, and 6, the static phosgene mixer 10 is placed directly at the bottom of the reactor/separator reservoir 1 below a liquid line 3. In this configuration, the distance between the outlet of the static phosgene mixer 10 and the reactor/separator reservoir 1 is even further reduced but not fully eliminated. FIG. 6 shows a configuration where the static phosgene mixer 1 is a static mixer with a guide element 89 as fully described in U.S. application Ser. No. ______, filed ______, and entitled Static Mixer, incorporated herein fully by reference.

FIG. 3, when compared with FIG. 2, shows a process for reducing the fouling and undesired by-products in a continuous preparation of organic isocyanates or polyisocyanates through the reaction of organic amines with phosgene in the presence of organic solvents under pressure. The process comprises the step of mixing a phosgene-containing stream shown as COCl₂ as shown in FIG. 3 with an amine-containing stream shown as PMDA in a static phosgene mixer 10 to create a mixture of reacting amine-phosgene that is sent to the reactor/separator reservoir 1. Further, the process includes the step of discharging the reacting amine-phosgene mixture in an isocyanate reactor/separator reservoir 1, where a conduit 6 and associated valve 8 shown by the letter A resides between an outlet of the static mixer 10 and the inlet of the reactor/separator reservoir 1, and is configured so a residence time of the stream of amine and phosgene is less than one second.

The static phosgene mixer 10 may be disposed below or attached to a wall 120 of the reactor/separator reservoir 1 shown in FIG. 6. In one embodiment, the isocyanate is selected from a group consisting diphenylmethane diisocyanate (MDI), polyphenelyne-polymethylene polyisocyanate (PMDI), tolylene diisocyanate (TDI), hexamethylene diisocyanate (HDI), isophorone diisocyanate (IPDI), or a mixture of diphenylmethane diisocyanate (MDI) and polyphenylene-polymethylene polyisocyanate (PMDI). A handful of isocyanates are listed, but any isocyanate, polyisocyanate, or any other compound with the same environmental constraints is applicable.

The fouling and undesired by-products created in the conduit at the outlet of the static phosgene mixer 10 and the reactor/separator reservoir 1 is reduced by either decreasing the interior diameter of the conduit, reducing the length of the conduit, or increasing the volumetric flow of the reacting amine-phosgene mixture, or any combination thereof.

A process for reducing the fouling and undesired by-products in a continuous preparation of organic isocyanates through the reaction of organic amines, such as PMDI, with phosgene in the presence of organic solvents under pressure using an annular mixer 10 is shown in FIG. 6. The process includes the step of mixing a phosgene-containing stream with an amine-containing stream in an annular static mixer 10 to create a combined jet of reacting amine-phosgene mixture. Further, the reactant is then discharged into a reactor/separator reservoir 1, as shown as part of the process in FIG. 3.

A conduit shown by A+B in FIG. 2, which is reduced to A in FIG. 3, is defined between an outlet of the static phosgene mixer 10 and the inlet of the reactor/separator reservoir 1 so that the residence time of the mixture in the conduit 6 or 6 and 8 is less than one second, and where the static mixer 10 comprises a first passageway 82 as shown in FIG. 6 defined by an inner surface of a housing 83, a second passageway 85 defined by at least one bore in communication with the first passageway 82 shown by the arrow, and a guide element 89 disposed in the first passageway 82 generally aligned with the second passageway 85, and where an annular mixing chamber is defined between the guide element 89 and the inner surface 83 adjacent the second passageway 85.

Persons of ordinary skill in the art appreciate that although the teachings of this disclosure have been illustrated in connection with certain embodiments and methods, there is no intent to limit the invention to such embodiments and methods. On the contrary, the intention of this disclosure is to cover all modifications and embodiments falling fairly within the scope the teachings of the disclosure.

What is claimed is:

1. A process for reducing the fouling and undesired by-products in a static mixer connected to a reactor/separator reservoir by a conduit, the process comprising the steps of:
mixing a phosgene-containing stream with an amine-containing stream in a static mixer to create a mixture of reacting amine-phosgene; and
discharging the mixture in the reactor/separator reservoir via a conduit,
wherein the conduit is connected at a first end to outlet of the static mixer and at a second end to an inlet of the reactor/separator reservoir so a residence time of the mixture in the conduit is less than one second.

2. The process of claim 1, wherein the outlet of the static mixer is adjacent to a reactor valve.

3. The process of claim 1, wherein the conduit has a length between the first end and the second end of no more than approximately 20 feet and the residence time of the mixture in the conduit is approximately 0.5 seconds at a full flow.

4. The process of claim 1, wherein the conduit has a length between the first and the second end of no more than approximately 20 feet and the residence time of the mixture in the conduit is approximately one second at a limited flow of 70% of the full flow.

5. The process of claim 1, wherein the conduit has a length between the first and the second end of no more than approximately 10 feet and the residence time of the mixture in the conduit is approximately a tenth of a second at a full flow.

6. The process of claim 1, wherein the conduit has a length between the first and the second end of no more than approximately 10 feet and the residence time of the mixture in the conduit is approximately two tenth of one second at a limited flow of 70% of the full flow.

7. The process of claim 1, wherein a distance between the outlet of the static mixer and the inlet of the reactor/separator reservoir is very short but not eliminated.

8. The process of claim 1, wherein the fouling and impurities creation is further reduced by either decreasing the interior diameter of the conduit, reducing the length of the conduit, or increasing a volumetric flow of the mixture, or any combination thereof.

9. The process of claim 1, wherein a reduction in length of the conduit by approximately 50% increases an operational life of the pipe reactor by at least 100%.

10. The process of claim 1, wherein a length of the conduit between the first end and the second end is reduced by approximately 50% and an operational life of the conduit is increased by more than 100% in time.

11. A process for reducing the fouling and undesired by-products in a static phosgene mixer with a guide element connected to a reactor/separator reservoir by a conduit, the process comprising the steps of:
mixing a phosgene-containing stream with an amine-containing stream in a static mixer to create a mixture of reacting amine-phosgene; and
discharging the mixture in the reactor/separator reservoir via a conduit,
wherein the conduit defined between an outlet of the static mixer and the inlet of the reactor/separator reservoir is configured so a residence time of the mixture in the conduit is less than one second, and
wherein the static mixer comprises a first passageway defined by an inner surface of a housing, a second passageway defined by at least one bore in communication with the first passageway, and a guide element disposed in the first passageway generally aligned with the second passageway; whereby an annular mixing chamber is defined between the guide element and the inner surface adjacent the second passageway.

12. The process of claim 11, wherein a distance between the outlet of the static mixer with guide element and the inlet of the reactor/separator reservoir is very short but not eliminated.

13. The process of claim 11, wherein the outlet of the static mixer is adjacent to a reactor valve.

14. The process of claim 11, wherein a distance between the outlet of the static mixer and the inlet of the reactor/separator reservoir is very short but not eliminated.

15. The process of claim 11, wherein the fouling and undesired by-products creation is further reduced by either decreasing the interior diameter of the conduit, reducing the length of the conduit, or increasing a volumetric flow of the mixture, or any combination thereof.

16. The process of claim 11, wherein a reduction in length of the conduit by approximately 50% increases an operational life of the pipe reactor by at least 100%.

17. The process of claim 11, wherein the conduit includes a first end adjacent to the outlet of the static mixer and a second end adjacent to the reactor/separator reservoir, and wherein a length of the conduit between the first end and the second end is reduced by approximately 50% and an operational life of the conduit is increased by more than 100% in time.
